(19) United States
(12) Patent Application Publication
(10) Pub. No.: US 2017/0122755 A1
(43) Pub. Date: May 4, 2017

(54) LANE SUGGESTION SYSTEMS

(71) Applicant: Toyota Motor Engineering & Manufacturing North America, Inc., Erlanger, KY (US)

(72) Inventors: Christopher Lee Rovik, Northville, MI (US); Eric Randell Schmidt, Northville, MI (US)

(21) Appl. No.: 14/925,214

(22) Filed: Oct. 28, 2015

(51) Int. Cl. G01C 21/34; G01S 19/42; G01C 21/36

(52) U.S. Cl. CPC G01C 21/3415; G01C 21/36; G01S 19/42

(57) ABSTRACT

A lane suggestion system for a vehicle is provided including a GPS unit and a processor in communication with the GPS unit, the processor configured to determine a first optimal lane of travel based on information received from the GPS unit, the processor configured to continuously monitor changes to vehicle data and external data. A second optimal lane based on the change in the vehicle data or the external data may be calculated by the processor. If the second optimal lane is most efficient, faster and/or safer as compared to the first optimal lane, then the second optimal lane is communicated to a user of the vehicle. If the first optimal lane of travel is the most efficient, faster and/or safer compared to the second optimal lane, then the first optimal lane of travel is continuously communicated to the user of the vehicle.

### TECHNICAL FIELD

The present specification generally relates to an apparatus and method for a system for suggesting a lane of travel and, more specifically, an apparatus and method for suggesting a specific lane of travel to a user in a vehicle to provide a preferred lane of travel based on preselected criteria.

### BACKGROUND

Navigational routing systems using GPS are known. While these systems may provide certain lane guidance relating to suggesting a lane because of an upcoming turn or exit, present systems do not provide for lane suggestion using information from sensors within the vehicle or from external third party or vehicle-to-vehicle data. Accordingly, there exists a need for alternative lane suggestion systems for providing a preferred lane of travel to a user in a vehicle.

### SUMMARY

In one embodiment, a lane suggestion system for a vehicle is provided including a GPS unit and a processor in communication with the GPS unit, the processor configured to determine a first optimal lane of travel based on information received from the GPS unit, the processor configured to continuously monitor changes to vehicle data and external data. If a change in either the vehicle data or the external data is detected by the processor, then the processor calculates a second optimal lane based on the change in the vehicle data or the external data. If the second optimal lane is most efficient, faster and/or safer as compared to the first optimal lane, then the second optimal lane is communicated to a user of the vehicle. If the first optimal lane of travel is the most efficient, faster and/or safer as compared to the second optimal lane, then the first optimal lane of travel is continuously communicated to the user of the vehicle.

In another embodiment, a lane suggestion system for a vehicle is provided having a GPS unit and a processor in communication with the GPS unit, the processor configured to determine a first optimal lane of travel based on information received from the GPS unit, the processor configured to continuously monitor changes to vehicle data and external data. If a change in either the vehicle data or the external data is detected by the processor, then the processor calculates if the change in the vehicle data or the external data alters the first optimal lane of travel. If the processor determines that the first optimal lane is altered, then a second optimal lane of travel is communicated to the user of the vehicle.

In yet another embodiment, a method of providing a lane suggestion to a user is provided including the steps of receiving input regarding a desired end location into a GPS unit, processing by a processor the input from the GPS unit to determine an first optimal lane of travel based on input from the GPS unit where the processor continuously monitors changes to both vehicle data and external data, the processor determining a second optimal lane of travel based on a change to the vehicle data and the external data and comparing by the processor of the first optimal lane of travel and the second optimal lane of travel, if the processor determines the second optimal lane of travel to be more efficient, faster and/or safer in comparison to the first optimal lane of travel, the processor then communicates the second optimal lane of travel to the user.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a flowchart for a lane suggestion system according to one or more embodiments shown and described herein;

FIG. 2A illustrates a logic flow and corresponding flowchart for the lane suggestion system of FIG. 1 according to one or more embodiments shown and described herein;

FIG. 2B illustrates a logic flow and corresponding flowchart for the lane suggestion system of FIG. 1 according to one or more embodiments shown and described herein;

FIG. 3 illustrates a logic flowchart of the lane suggestion system of FIG. 1 according to one or more embodiments shown and described herein;

FIG. 4 depicts an illustrative example where the lane suggestion system of FIG. 1 may be utilized according to one or more embodiments shown and described herein;

FIG. 5 illustrates a flowchart of the lane suggestion system of the example as illustrated in FIG. 4 according to one or more embodiments shown and described herein;

FIG. 6 depicts an exemplary embodiment of a vehicle situation where the lane suggestion system of FIG. 1 may be used according to one or embodiments shown and described herein;

FIG. 7 depicts a flowchart for the example as illustrated in FIG. 6 of the lane suggestion system according to one or more embodiments shown and described herein;

FIG. 8 depicts an example of a road condition using the lane suggestion system of FIG. 1 according to one or more embodiments shown and described herein; and

FIG. 9 illustrates a flowchart in accordance with the example as illustrated in FIG. 8 for the lane suggestion system according to one or more embodiments shown and described herein.

### DETAILED DESCRIPTION

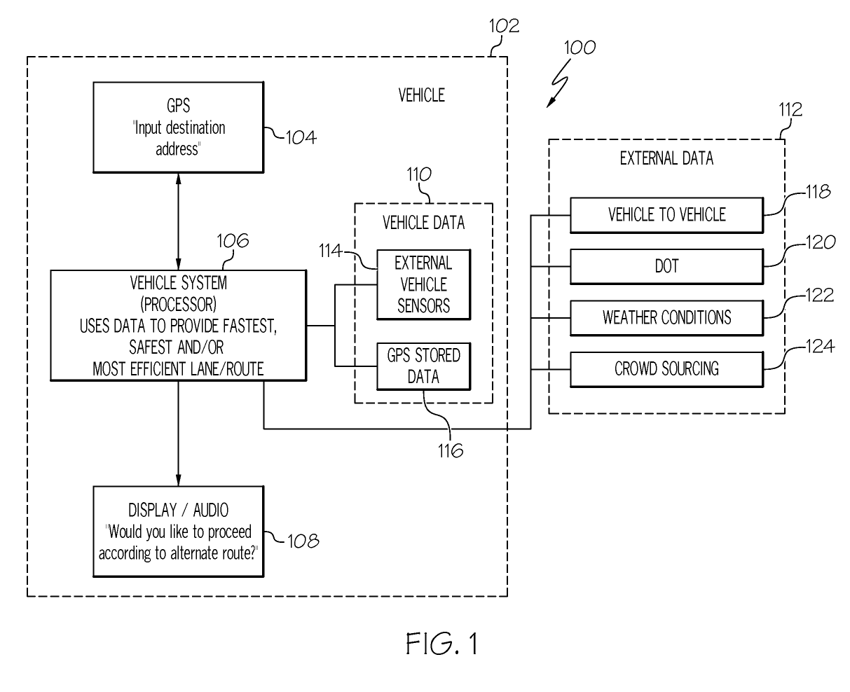

FIG. 1 generally depicts one embodiment of a lane suggestion system for determining and communicating a preferred lane of travel to a user driving a vehicle. The system within the vehicle includes a GPS unit, a processor, and a display and/or audio system to communicate information to the user. The processor is configured to receive vehicle data and external data. Vehicle data generally includes external vehicle sensors and GPS stored data. External data includes vehicle-to-vehicle information, Department of Transportation data, weather conditions, and/or crowdsourcing information. The vehicle data and the external data are communicated to the processor so that the processor can determine, based on preselected criteria, and communicate the preferred lane or route to the user.

A lane suggesting system 100 for a vehicle 102 is provided having a GPS unit 104, a processor 106, and a communication system 108. The GPS unit 104 is mounted within the vehicle and configured to determine location and to determine a route of travel based on input from a user. The GPS unit 104 is in direct communication with the processor 106. The processor 106 receives both vehicle data 110 and external data 112. The processor 106 uses the vehicle data 110 and the external data 112 to determine a preferred lane of travel based on preselected criteria(e.g., the fastest, safest, and/or most efficient lane of travel (or route)). The preselected criteria can be related to vehicle volume, distances, weather conditions, construction, road conditions, etc.

The vehicle data 110 may include information received from external vehicle sensors 114. The external vehicle sensors 114 may be sensors mounted to exterior body panels of a vehicle to collect information such as the proximity of other vehicles (e.g., to identify vehicles traveling too close to the user vehicle). The vehicle data 110 may include GPS stored data 116. The GPS stored data 116 may include learned information by the GPS unit 104 and the processor 106 relating to lane travel on a particular route.

The external data 112 may be data relating to vehicle-to-vehicle (V2V) 118, information from the Department of Transportation (DOT) 120, information relating to weather conditions 122, and/or information from crowdsourcing 124.

Vehicle-to-vehicle information 118 from the external data 112 may include information transferred from other surrounding vehicles relating to emergency vehicles 130, student drivers 132, and/or learned information 134. Vehicle-to-vehicle systems, such as those used to collect vehicle-to-vehicle information 118 such as in the present specification, are an automotive technology designed to allow automobiles to “talk” to each other. Vehicle-to-vehicle systems frequently use a region of the 5.9 gHz band. Alternatively, vehicles using vehicle-to-vehicle technology may communicate via Bluetooth or other known sources.

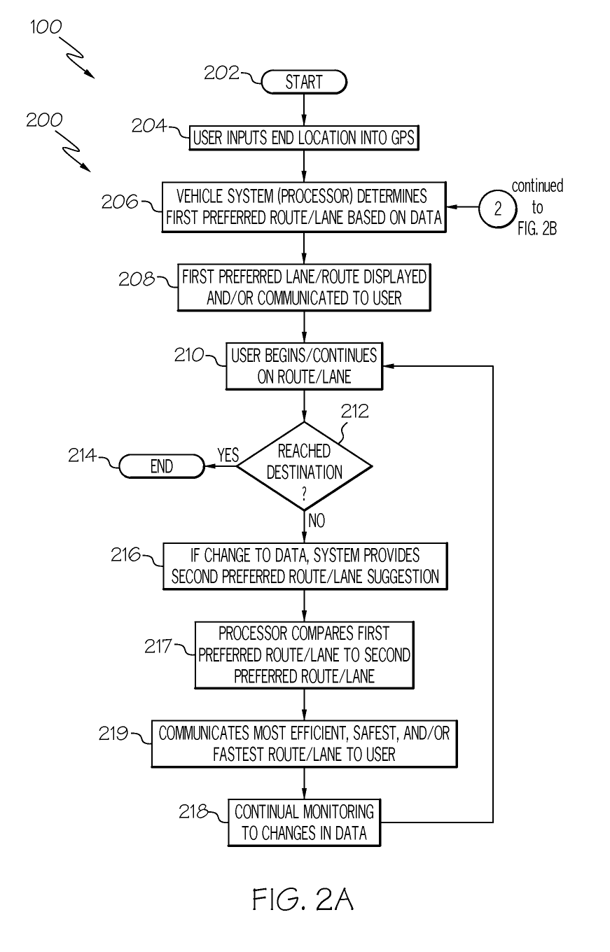

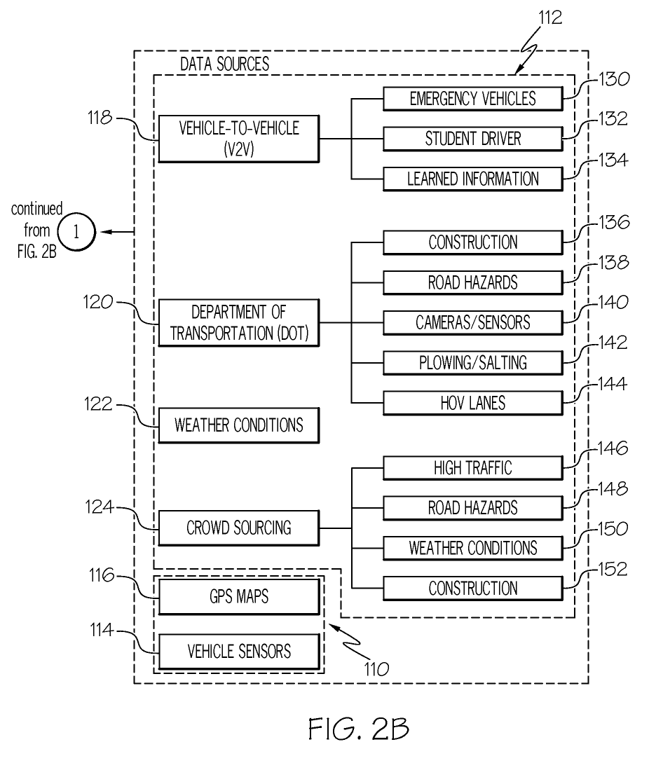

In some embodiments, such as illustrated in FIGS. 1 and 2, the processor uses the external data 112 source of information from the Department of Transportation 120. Information from the Department of Transportation 120 may be communicated to the processor by means of a cloud based storage system over Wi-Fi or a cellular network. Information from the Department of Transportation may include construction information 136, road hazards 138, cameras, sensors 140, plowing/salting 142, and/or high occupancy vehicle (HOV) lanes 144. Construction information 136 may include specific lanes that are closed due to construction or moving work crews filling potholes. Road hazards 138 may include information communicated from the Department of Transportation regarding debris in the road, vehicles on the shoulder, and/or other potentially hazardous items or conditions.

Cameras or sensors 140 operated by the Department of Transportation 120 may include cameras or sensors mounted to roadways to monitor flow of traffic and/or accidents on a particular road or in a particular lane. The Department of Transportation 120 may also monitor plowing/salting 142 on specific lanes of travel. If a particular lane has been plowed and salted, that information may be communicated to the processor 106. Furthermore, high occupancy vehicle (HOV) lanes 144 in certain areas may be communicated from the Department of Transportation 120 to the processor 106 for purposes of determining a preferred lane of travel.

Weather conditions 122 may be communicated via a cloud or other cellular network to the processor 106. Weather conditions 122 may include information relating to an incoming storm, ice over the road, snow on the road, hail, or other similar road conditions which may pose non-optimal driving and/or lane conditions.

Crowdsourcing 124 may also be used to determine an optimal lane of travel. Crowdsourcing 124 may be communicated to the processor 106 by means of the cloud over a cellular or Wi-Fi network. Crowdsourcing information may include high traffic areas 146, road hazards 148, weather conditions 150, and/or construction 152. Crowdsourced information may be acquired from various users of crowdsourcing 124 whereby the users input information relating to high traffic areas 146, road hazards 148, weather conditions 150, and/or construction 152 into the crowdsourcing 124 program. Information relating to crowdsourcing 124 may then be communicated to the processor 106 through a Wi-Fi or cellular connection.

Referring now to FIGS. 2A and 2B, the system 100 completes the steps as illustrated in the flowchart 200. The user starts by inputting end location information 204 into the GPS unit 104. The processor 106 then determines a first preferred lane/route based on vehicle data 110 and/or external data 112, as illustrated by reference numeral 206. Step 208 displays the first preferred lane/route to the user. Alternatively, the first preferred lane/route is audibly communicated to the user. At step 210, the user begins/continues on the lane as suggested by the first preferred lane. The logic flowchart 200 then determines if the vehicle has reached its destination at step 212. If the user has reached the destination, the process is ended 214. If the user has not reached a final destination, the system moves on to the next step.

In this embodiment, if the processor 106 determines that the data 110, 112 has changed, the processor 106 then determines a second preferred lane of travel based on the data 110, 112. At step 217, the processor 106 compares the first preferred lane to the second preferred lane. Step 219 requires communication of the preferred lane (e.g., most efficient, safest, and/or fastest lane) to the user based on the processor 106 determination. If the processor determines that the second preferred lane best meets the preselected criteria, (e.g., is more efficient, safer, and/or faster), then the second preferred lane is displayed or otherwise communicated to the user. If the processor 106 determines that the first preferred lane still best meets the preselected criteria (e.g., is still the most efficient, fastest, and/or safest), then no change is communicated to the user and the user is instructed to continue on the lane they are currently in. The system continuously monitors 218 changes to vehicle data 110 and external data 112.

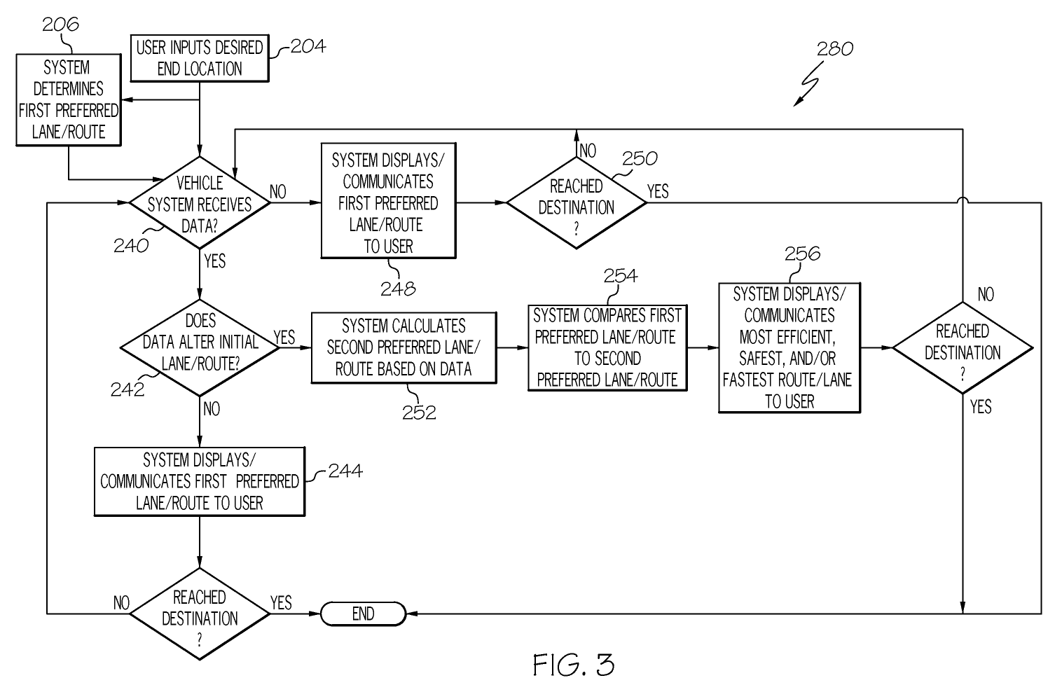

Referring now to FIG. 3, a logic flowchart 280 is provided depicting another embodiment of the present lane suggestion system. As previously discussed, the user inputs information into the GPS unit and the processor determines a first preferred lane of travel. The processor 106 then receives data 240 and the processor determines 142 if the first preferred lane is altered. If the first preferred lane is altered, the processor 106 calculates 252 a second preferred lane. The system then compares 254 the first preferred lane to a second preferred lane. The system then displays/communicates 250 the most efficient and/or safest route/lane to the user based on the processor 106 determination and comparison. If the user has reached their final destination, the process ends. If the user has not reached the final destination, the system then continuously monitors changes in receipt of data, such as illustrated at reference numeral 240.

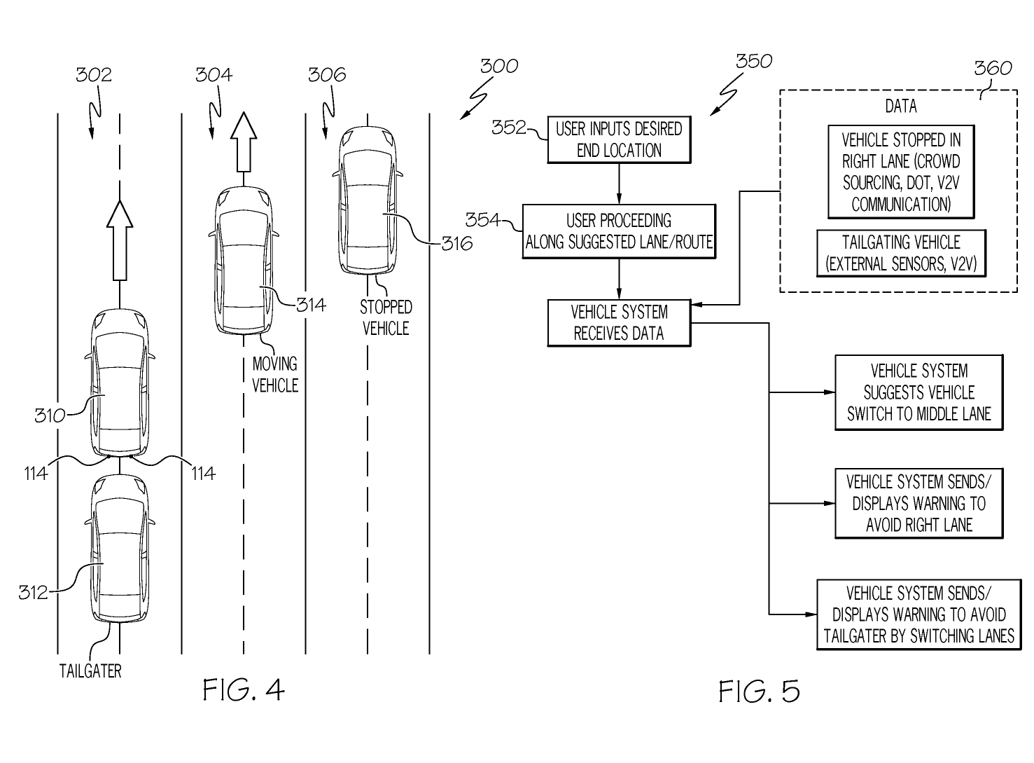

Referring now to FIGS. 4 and 5, an example lane condition 300 is provided with a corresponding flowchart 350 for providing a lane suggestion in accordance with one embodiment of the present lane suggestion system. The lane condition 300 includes a first lane 302, a second lane 304, and a third lane 306. The first lane 302 includes the user vehicle 310.

The user vehicle 310 includes the lane suggestion system in accordance with one or more embodiments shown and described in the present specification. In the lane condition 300, a tailgater 312 is provided within the first lane 302, a moving vehicle 314 is provided in the second lane 304 directly adjacent to the user vehicle 310. The third lane 306 includes a stopped vehicle 316. In the lane condition 300, the user of the user vehicle 310 is unaware of the stopped vehicle 316 within lane 306. The moving vehicle 314 is moving generally at the same speed as the user vehicle 310 and the tailgater 312.

In an exemplary flow of steps for the lane condition 300, the method would include the steps of inputting a desired end location 352, a user proceeding along the suggested lane 354, the vehicle system receiving data 360 relating to the stopped vehicle 316 and the tailgater 312. Data relating to the stopped vehicle is communicated to the processor 106 by means of crowdsourcing, the Department of Transportation, and/or vehicle-to-vehicle communications. Data relating to the tailgater 312 is communicated to the processor 106 by means of the external vehicle sensors 114 on the vehicle 310. The processor 106 then determines that an alternate lane should be used. In some embodiments, the system may communicate to the user that the vehicle should switch to the middle lane. Alternatively, the processor may display a warning to avoid the far right lane (i.e. the third lane 306). In other embodiments, the processor may display a warning to avoid the tailgater 312 by switching to the middle lane.

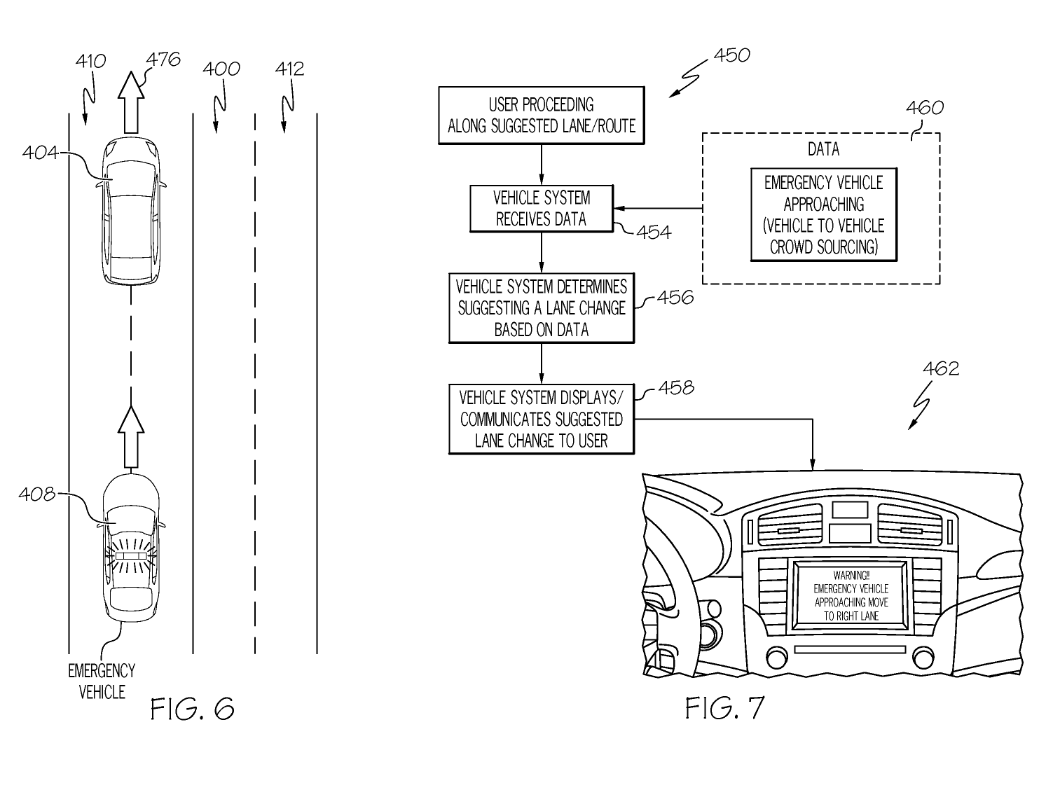

Referring now to FIGS. 6 and 7, an example lane condition 400 is provided having a user vehicle 404. The user vehicle 404 is driving within a first lane 410 which is directly adjacent to a second lane 412. The user 404 is moving in a forward direction 406. In this embodiment, an emergency vehicle 408 is quickly approaching the user vehicle 404. As in other embodiments, the flowchart 450 illustrates the user initiating the process by proceeding along the suggested lane.

The processor 106 then receives data 460 as illustrated by reference numeral 454. The vehicle system determines that the user vehicle 404 should switch lanes based on the data 460. In this embodiment, the data 460 indicates to the processor 106 that the emergency vehicle 408 is approaching. This information is communicated to the processor 106 by means of vehicle-to-vehicle communication and/or crowdsourcing. The processor then displays/communicates the suggested lane change to the user, such as illustrated by reference numeral 458. The display may be similar to what is illustrated on a dashboard 462: “Warning! Emergency vehicle approaching move to right lane.”

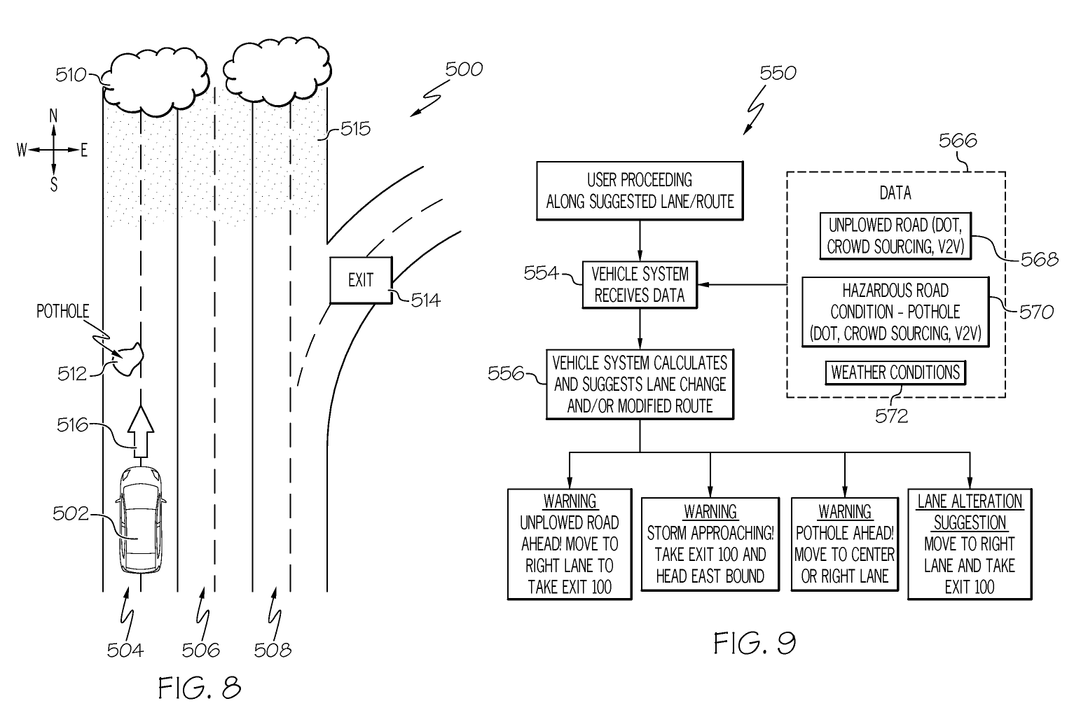

Referring now to FIGS. 8 and 9, an exemplary lane condition 500 is depicted. Lane condition 500 includes a user vehicle 502 driving within a first lane 504. An adjacent second lane 506 and third lane 508 are also provided. The user vehicle 502 is moving in a forward direction 516 towards a pothole 512 and inclement weather 510. The inclement weather 510 has produced unsavory road conditions 515. The lane condition 500 further depicts the third lane 508 adjacent to an exit 514.

The flowchart 550 illustrates the exemplary steps of the system taken in the lane condition 500. The processor 106 receives 554 data 566 relating to an unplowed road 568, hazardous road conditions 570, and the weather conditions 572. The processor then calculates 556 a lane change to the user of the user vehicle 502. Exemplary displays to the user may include suggestions to change lanes to avoid the pothole and/or to take the exit to avoid the unsavory road conditions 515 and inclement weather 510.

The present system allows the user of the system to find a preferred lane or route when traveling. The system integrates third party data which provides specific information to the system which then determines a preferred route. This provides the advantages that the exact specific lane of travel (or route) can be provided to the user thereby making a more desirable driving experience to the user.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A lane suggestion system for a vehicle comprising:
a GPS unit; and
a processor in communication with the GPS unit, the processor configured to determine a first preferred lane of travel based on information received from the GPS unit, the processor configured to continuously monitor changes to vehicle data and external data;
wherein if a change in either the vehicle data or the external data is detected by the processor, the processor calculates a second optimal lane based on the change in the vehicle data or the external data and preselected criteria,
if the second optimal lane best meets the preselected criteria as compared to the first optimal lane, the second optimal lane is communicated to a user of the vehicle;
if the first optimal lane of travel best meets the preselected criteria as compared to the second optimal lane, the first optimal lane of travel is communicated to the user of the vehicle.

2. The lane suggestion system of claim 1 wherein the vehicle data is data received from a sensor mounted to the vehicle, the sensor mounted externally.

3. The lane suggestion system of claim 1 wherein the vehicle data is data stored within the processor relating to learned GPS information.

4. The lane suggestion system of claim 1 wherein the external data is communicated to the processor over a cellular network.

5. The lane suggestion system of claim 1 wherein the external data is communicated to the vehicle from a secondary vehicle via vehicle-to-vehicle communication.

6. The lane suggestion system of claim 1 wherein the external data relates to road hazards, construction, road conditions and/or high occupancy vehicle lane information.

7. The lane suggestion system of claim 1 wherein the external data is crowdsourced data, the crowdsourced data being high traffic areas, road hazards, weather conditions, road conditions and/or construction.

8. The lane suggestion system of claim 1 wherein the second optimal lane is communicated to the user audibly and/or graphically.

9. A lane suggestion system for a vehicle comprising:
a GPS unit; and
a processor in communication with the GPS unit, the processor configured to determine a first preferred lane of travel based on information received from the GPS unit, the processor configured to continuously monitor changes to vehicle data and external data;
wherein if a change in either the vehicle data or the external data is detected by the processor, the processor calculates if the change in the vehicle data or the external data alters the first preferred lane of travel;
if the processor determines that the first preferred lane is altered, then a second preferred lane of travel is communicated to the user of the vehicle.

10. The lane suggestion system of claim 9 wherein the vehicle data is data received from a sensor mounted to the vehicle, the sensor mounted externally.

11. The lane suggestion system of claim 9 wherein the vehicle data is data stored within the processor relating to learned GPS information.

12. The lane suggestion system of claim 9 wherein the external data is communicated to the processor over a cellular network.

13. The lane suggestion system of claim 9 wherein the external data is communicated to the vehicle from a secondary vehicle via vehicle-to-vehicle communication.

14. The lane suggestion system of claim 9 wherein the external data relates to road hazards, construction, road conditions and/or high occupancy vehicle lane information.

15. The lane suggestion system of claim 9 wherein the external data is crowdsourced data, the crowdsourced data being high traffic areas, road hazards, weather conditions, road conditions and/or construction.

16. The lane suggestion system of claim 9 wherein the second optimal lane of travel is communicated to the user audibly and/or graphically.

17. A method of providing a lane suggestion to a user, the method comprising the steps of:
receiving input regarding a desired end location into a GPS unit;
processing by a processor the input from the GPS unit to determine a first preferred lane of travel based on input from the GPS unit;
the processor continuously monitoring changes to both vehicle data and external data, the processor determining a second preferred lane of travel based on a change to the vehicle data and the external data; and
comparing by the processor of the first preferred lane of travel and the second preferred lane of travel, if the processor determines the second preferred lane of travel to best meet preselected criteria in comparison to the first preferred lane of travel, the processor then communicates the second preferred lane of travel to the user.

18. The method of claim 17 wherein the processor graphically displays and/or audibly communicates the second preferred lane of travel to the user.

19. The method of claim 17 wherein the processor continuously monitors change to both the vehicle data and the external data even after a second preferred lane of travel has been communicated to the user.

20. The method of claim 17 wherein the external data is communicated to the vehicle from a secondary vehicle via vehicle-to-vehicle communication.
